(19) United States
(12) Patent Application Publication
(10) Pub. No.: US 2007/0112819 A1
(43) Pub. Date: May 17, 2007

(54) Logic checker using semantic links

(75) Inventors: Richard Dean Dettinger, Rochester, MN (US); Frederick Allyn Kulack, Rochester, MN (US); Kevin Glynn Paterson, San Antonio, TX (US)

Correspondence Address: WOOD, HERRON & EVANS, L.L.P. (IBM), 2700 CAREW TOWER, 441 VINE STREET, CINCINNATI, OH, 45202, US

(73) Assignee: INTERNATIONAL BUSINESS MACHINES CORPORATION, Armonk, NY (US)

(21) Appl. No.: 11/282,078

(22) Filed: Nov. 17, 2005

(51) Int. Cl. G06F 7/00

(52) U.S. Cl. 707/101

(57) ABSTRACT

A semantic link is established in a document in connection with content being inserted into first and second portions of a document. Content in the first portion includes a linguistic expression, and is logically related to the content in the second portion. A semantic link is generated in the document that logically links the content of the first portion of the document to the content of the second portion of the document. The semantic link is configured to initiate performance of an action on content in either of the first or second portions of the document in response to a determination that a content modification made to content in the other of the first or second portions of the document is a semantic modification that creates a semantic inconsistency, based at least in part upon a meaning of the linguistic expression, between the first and second portions of the document.

### FIELD OF THE INVENTION

The present invention generally relates to computers and computer software, and more particularly, to semantic analysis of content in electronic documents.

### BACKGROUND OF THE INVENTION

A number of computer technologies have been developed to assist authors in drafting and revising electronic content. For example, word processors have been supplemented with a number of tools such as spell checkers, grammar checkers, electronic thesauruses, etc. to identify potential errors in a document and suggest corrections thereto. In addition, some of these tools have “correct as you go” capabilities where errors are identified as text is entered, and optionally corrected on the fly.

In addition, some word processors and other programs include automated tools such as outline, index, table of contents and table of authorities tools that are capable of organizing a document and generating supplemental content such as indices, tables of content, tables of authority, cross-references, etc. based upon links defined in the document by a user.

With indices, tables of content and tables of authority tools, for example, a user selects text to be added as an entry in the relevant index or table, and the program tags the text so that the program can later generate the index or table when so requested by the user. Alternatively, a user can tag certain text with specific styles to indicate that the text should be incorporated into a table.

With cross-references, a user typically selects a specific position in a document and marks that position as a target, then creates a reference to that target that can later be updated based upon the type of reference chosen. For example, a user can specify that the reference is a page number reference, such that the reference displays the current page number of the target (e.g., “a further discussion of this topic is found on page X below”). Then, as the page number of the target changes as other text is added or removed to or from the document, the reference may be automatically updated accordingly.

Many word processors also support various tools for automating document content creation. For example, templates may be defined for certain document types, with capabilities provided for receiving user input and/or merging information from a file or database to automatically generate a custom document from a template. Many word processors also support macros and high level programming languages to enable end users to further automate content creation.

In other types of programs similar functionality exists. For example, spreadsheet programs provide the ability to define formulas in particular cells in a spreadsheet that are based upon the contents of other cells. Any time the content of a cell changes, the content of any cell having a formula that references the changed cell is likewise updated. While most formulas are based on numerical data, some can be based upon textual data, e.g., through the use of literal text strings.

A common characteristic of these various tools is a requirement on the part of the user to have a fairly high level of familiarity and expertise with the particular procedures required to utilize the tools. Furthermore; it is incumbent on the part of the user to understand the context and semantics of the content that is being used or generated. As an example, if a user desires to create a table of authorities, it is a requirement for the user to identify the particular content that corresponds to an item to be included in the table. The tool itself is generally not capable of analyzing the content to identify appropriate content for inclusion in the table.

Despite the aforementioned tools and functions, drafting and revising electronic content still remains a daunting task for many subject areas. For example, in a research environment such as medical research or computer performance analysis, it is common to draft documents that follow a typical pattern in their overall structure, e.g., generally along the lines of: (1) hypothesis; (2) assumptions/facts; (3) measurements/experiments; (4) analysis; and (5) conclusions. In some instances, these sections will be clearly delineated; however, in other instances, the separation of these sections in a real document is not necessarily so clear and distinct. There may be many subtly related sections or chapters, each of which talks about a different aspect of the subject under research. Those sections or chapters may also include various interrelated details, may refer to each other, or may be in an order that makes sense from either a presentation, logical, physical or technical perspective. The document probably typifies a working document, and may or may not be a version of the final document that is presented/posted to whatever entity is going to consume the research.

Making changes to a more complex document as the document becomes larger and the research information becomes more complex becomes increasingly difficult. For example, information in a document may change, perhaps due to updated research and facts, new experimental methods or results, and even the results of the analysis. Coordinating the drafting of new portions of a document and/or the revision of existing portions of a document to reflect the changed information can be exceptionally difficult, particularly when different portions of the document are logically related to one another. A change to the content in one portion of a document may create an inconsistency with content in other portions of the document, and typically a user is required to manually search through a document after making a change to one portion of the document to ensure that the remainder of the document is consistent with the content in the changed portion of the document.

Word processors and other programs support find and replace functions, which permit a user to search for specific text and replace that text with other text. Thus, for some content changes in a document, a user may simply be able to replace changed text throughout a document. As an example, if a computer performance analysis document mentions that a particular system under test has a 500 MHz processor, and that processor is mentioned in several locations of the document, a simple search and replace could be used to change all references to the processor speed to 1.2 GHz if the processor is replaced with a faster model.

In many instances, however, the changes to a document are semantic in nature, i.e., the changes effectively alter the meaning of the content rather than the verbatim text of the content. In addition, many of these changes are to linguistic expressions in a document, rather than simply to numerical data. As a result, existing find and replace tools are often incapable of locating and/or modifying related content in a document to address the semantic inconsistencies that might arise in a document after content in the document has been changed.

For example, a computer performance analysis document might compare the performance of systems A and B, and provide tables of performance data gathered during testing. The analysis and conclusion sections of the document might state that system A is faster than system B, or that system A was found to be only lightly loaded during testing. If later testing is performed that shows that in other situations system B is faster than system A, or that system A becomes more heavily loaded, the changes required elsewhere in the document amount to more than a simple replacement of verbatim text. Often, an author is required to manually review and edit the document to address any such semantic inconsistencies.

Therefore, a significant need continues to exist for a tool capable of assisting authors in maintaining semantic consistency when drafting and revising electronic documents, particularly with regard to linguistic expressions in such documents.

### SUMMARY OF THE INVENTION

The invention addresses these and other problems associated with the prior art by providing an apparatus, program product and method that utilize semantic links to logically link together related content in one or more electronic documents. For example, in some embodiments, a semantic link may be established between different portions of a document, where one portion includes a linguistic expression. Automated analysis may be performed on one or both of the linked portions subsequent to a modification made to the content of one of the portions to determine whether the modification results in a semantic inconsistency that is based at least in part on the meaning of the linguistic expression. In various embodiments of the invention, the content in the other portion of the document may then be acted upon in various different manners to facilitate the remediation of the semantic inconsistency. Moreover, in some embodiments a semantic link may be established between different portions of different documents, thus addressing semantic inconsistencies that may arise between logically-related content in different documents.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram illustrating the principal hardware and software components in a computer that utilizes semantic links consistent with the invention.

FIGS. 2-4 are flowcharts illustrating a sequence of steps utilized in manually creating and utilizing a semantic link in the computer of FIG. 1.

FIG. 5 is a block diagram illustrating an exemplary document incorporating semantic links and displayed by the computer of FIG. 1.

### DETAILED DESCRIPTION

The herein-described embodiments utilize semantic links to link together logically-related content in one or more electronic documents for the purposes of maintaining semantic consistency between the logically related content. The logically-related content typically includes one or more linguistic expressions, i.e., expressions comprising multiple words from a human readable language, rather than simply numerical data, which conveys a particular meaning to a reader. A word is typically understood by one skilled in the art as a combination of sounds or phonemes (or textual representations of such sounds or phonemes) that conveys a particular meaning within the context of a language.

Semantic links are used to assist in the automated detection of semantic inconsistencies between logically-related content. A semantic inconsistency, within this context, arises when the meaning of certain content, e.g., a linguistic expression, becomes incompatible with other content with which that content is logically-related, typically as a result of a modification being made to the content of an electronic document. As will be discussed in greater detail below in connection with an illustrative example, one example of a semantic inconsistency might arise due to gender references, e.g., when logically-related content refers in one place to a “grandmother” followed by the use of the pronoun “she” in another place in reference to the same person, and a modification is then made to change the word “grandmother” to “grandfather” without changing the later pronoun reference. Another example where a semantic inconsistency might arise is when the meaning of certain content is negated, or when the ordering of items in a list is changed, where the order of the list implies priority. It will be appreciated that an innumerable number of types of semantic inconsistencies might arise when changing content in an electronic document, and as such, the invention is not limited to the particular types of inconsistencies that have been enumerated herein.

In addition, while the illustrated embodiments focus on semantic links established between logically-related content in the same electronic document, in other embodiments, semantic links may be established between logically-related content in multiple documents. By doing so, a number of unique applications may be supported. For example, a shared ‘fact document’ may be linked to one or more documents in an organization or other shared environment, and could be used to detect semantic inconsistencies with other documents in the organization. In a commercial environment, for example, such an embodiment would assist in ensuring that all company documents are consistent with information that the company deems to be correct in the fact document. Likewise, in any community or collaborative environment, e.g., an Internet-accessible scientific or research environment, semantically linking multiple documents to a given fact document containing information known to be true or correct provides the ability to flag potential semantic inconsistencies in other documents made available in the environment.

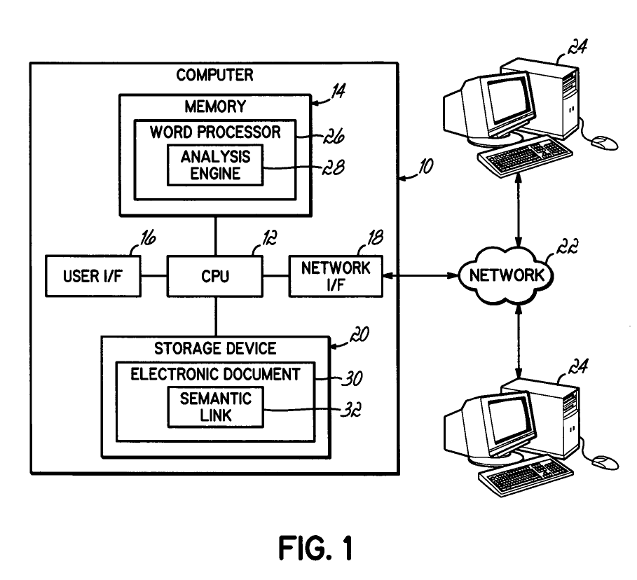

Now turning to the Drawings, wherein like numbers denote like parts throughout the several views, FIG. 1 illustrates an exemplary hardware and software environment suitable for utilizing semantic links consistent with the invention. In particular, FIG. 1 illustrates an apparatus 10, which may be implemented by practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer,” although it should be appreciated the term “apparatus” may also include other suitable programmable electronic devices consistent with the invention.

Computer 10 typically includes a central processing unit (CPU) 12 including one or more microprocessors coupled to a memory 14, which may represent the random access memory (RAM) devices comprising the main storage of computer 10 as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor in CPU 12, as well as any storage capacity used as a virtual memory, e.g., as stored on a mass storage device 20 or on another computer coupled to computer 10.

Computer 10 also typically receives a number of inputs and outputs for communicating information externally. For interface with a user or operator, computer 10 typically includes a user interface 16 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal coupled to the computer (e.g., one of computers 24 coupled to computer 10 over network 22, if computer 10 is implemented as a server or other multi-user computer).

For non-volatile storage, computer 10 typically includes one or more mass storage devices 20, e.g., a floppy or other removable disk drive, a hard disk drive, a direct access storage device (DASD), an optical drive (e.g., a CD drive, a DVD drive, etc.), and/or a tape drive, among others. Furthermore, computer 10 may also include an interface 18 with one or more networks 22 (e.g., a LAN, a WAN, a wireless network, and/or the Internet, among others) to permit the communication of information with other computers and electronic devices. It should be appreciated that computer 10 typically includes suitable analog and/or digital interfaces between CPU 12 and each of components 14-20, as is well known in the art.

Computer 10 operates under the control of an operating system (not shown), and executes or otherwise relies upon various computer software applications, components, programs, objects, modules, data structures, etc. (e.g., a word processor 26 with an analysis engine 28 suitable for analyzing content in an electronic document 30 incorporating one or more embedded semantic links 32). Moreover, various applications, components, programs, objects, modules, etc. may also execute on one or more processors in another computer coupled to computer 10 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to tangible, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

The herein-described embodiments create and utilize semantic links to maintain semantic consistency in an electronic document. As noted above, a semantic link is generated in a document to logically link the content of a first portion of the document to the content of a second portion of the document. The semantic link is configured to initiate performance of an action on content in either the first or second portions of the document in response to a determination that a content modification made to the document creates a semantic inconsistency between the linked portions of the document, where the semantic inconsistency is based at least in part upon a meaning of a linguistic expression in a portion of the document.

In the illustrated embodiment, semantic link processing is implemented in word processor 26, and furthermore relies on a text analysis engine 28 that may be incorporated into word processor 26, or alternately implemented as a separate application. It will be appreciated, however, that semantic links may be utilized in connection with other types of content creation and/or editing tools, as well as with other types of electronic documents. For this reason, the discussion hereinafter may refer to a “logic checker”, which represents any program code, whether or not incorporated into a word processor or other application, that is configured to utilize semantic links in a manner consistent with the invention. Furthermore, as shown in FIG. 1, a semantic link 32 may be embedded in an electronic document 30; however, in other embodiments, semantic links may be maintained separately from a document, and may be implemented in a wide variety of different data structures.

Text analysis engine 28 may be implemented in a number of manners consistent with the invention. Text analysis engine 28 may be implemented, for example, as an unstructured text analysis engine, which attempts to detect patterns or trends in a corpus of unstructured documents. Often such text analysis is used to categorize documents or identify relationships between documents or concepts, often in connection with database searching and data mining. Text analysis engines often have the ability to parse documents to identify unique concepts, grammatical parts of speech, proper names, etc., as well as to identify related concepts in the documents that tend to indicate contextual relationships between those concepts. Often, text analysis tools are used in specific knowledge areas, such as medical, financial, etc., and may find use in connection with natural language searching, fuzzy searching, and mining a collection of documents for important concepts and trends.

One implementation of text analysis engine 28 may rely on an unstructured information management (UIM) architecture to analyze unstructured information (text, audio, video, images, etc.) to discover, organize, and deliver relevant knowledge to the user. In analyzing unstructured information, UIM applications typically make use of a variety of analysis technologies, including statistical and rule-based Natural Language Processing (NLP), Information Retrieval (IR), machine learning, and ontologies. One such UIM architecture that may be used, for example, is the UJMA framework available from International Business Machines Corporation.

UIMA is an architecture in which basic building blocks called Analysis Engines (AE's) are composed in order to analyze a document. AE's include annotators within which are packaged the analysis algorithms utilized by the AE's. A Common Analysis Structure (CAS) is defined in UIMA to enable composition and reuse of analysis results. The CAS is an object-based container that manages and stores typed objects having properties and values. Object types may be related to each other in a single-inheritance hierarchy. Annotations are a special kind of feature structure that is designated for linguistic analysis processing. A feature structure spans or covers a piece of input text and is defined in terms of its beginning and end positions in the input text. Annotators are given a CAS having the subject of analysis (the document), in addition to any previously created objects (from annotators earlier in the pipeline), and they add their own objects to the CAS. The CAS serves as a common data object, shared among the annotators that are assembled for an application.

A feature structure an attribute-value structure that serves as the underlying data structure to represent the result of an analysis. Each feature structure is of a type, with every type having a specified set of valid features or attributes (properties). Features may also have a range type that indicates the type of value that the feature must have, for example, String.

It will be appreciated that a wide variety of alternate text analysis engines and architectures may be utilized in other embodiments. Therefore, the invention is not limited to use with the specific text analysis engine and architecture described herein. It will also be appreciated that implementation of the herein-described functionality using a text analysis engine such as that supported by the UIMA architecture would be well within the abilities of one of ordinary skill in the art having the benefit of the instant disclosure.

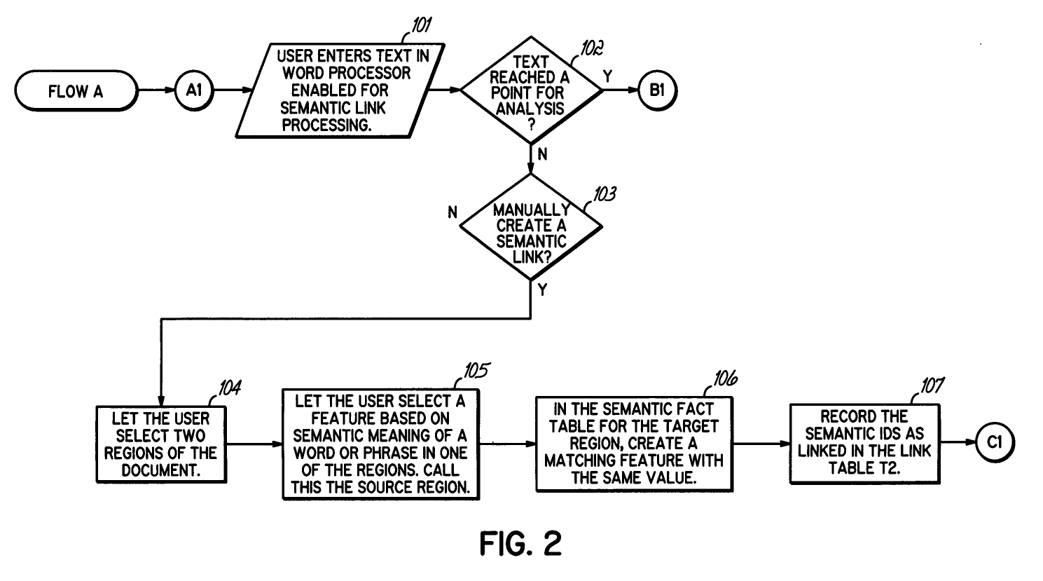

Now turning to FIGS. 2-4, these figures illustrate the sequence of steps that may be utilized by word processor 26 in computer 10 to create and utilize a semantic link consistent with the invention, e.g., a semantic link 32 embedded in an electronic document 30 (FIG. 1). Links in the illustrated embodiment are represented in a semantic link table, which includes an entry for each semantic link that identifies one or more source semantic identifiers and one or more target semantic identifiers that identify logically-related content in an electronic document. Each semantic identifier is used to uniquely identify an entry in a separate semantic fact table. As will become more apparent below, each entry in the semantic fact table represents a semantic concept and identifies a particular region, a type and one or more features. Each feature is a fact associated with the text in a particular region, and is typically represented via an attribute and a value. In addition, it may be desirable to utilize, in connection with explicitly defined or detected features, dependent or calculated features that are based upon other defined features. As one example, a cost feature may be defined that is based upon numerical cost values defined in other features, e.g., to represent a sum of multiple cost features. It will be appreciated that the tables used in the illustrated embodiment are merely exemplary in nature, and other data structures may be used in other embodiments.

FIG. 2 illustrates the sequence of steps that may be performed in connection with creating a semantic link consistent with the invention. In particular, in block 101, a user enters text in a word processor that is enabled for semantic link processing. In block 102, a determination is made as to whether an analysis of the text entered needs to be performed. The “point appropriate for analysis” may be when the user completes a section, a paragraph, a sentence, or a word in a document (e.g., as triggered by typing a space or hitting the enter key), or alternatively via continuous, background monitoring. In the alternative, the point may arise in response to specific user input, or in connection with another operation, e.g., in connection with saving the document.

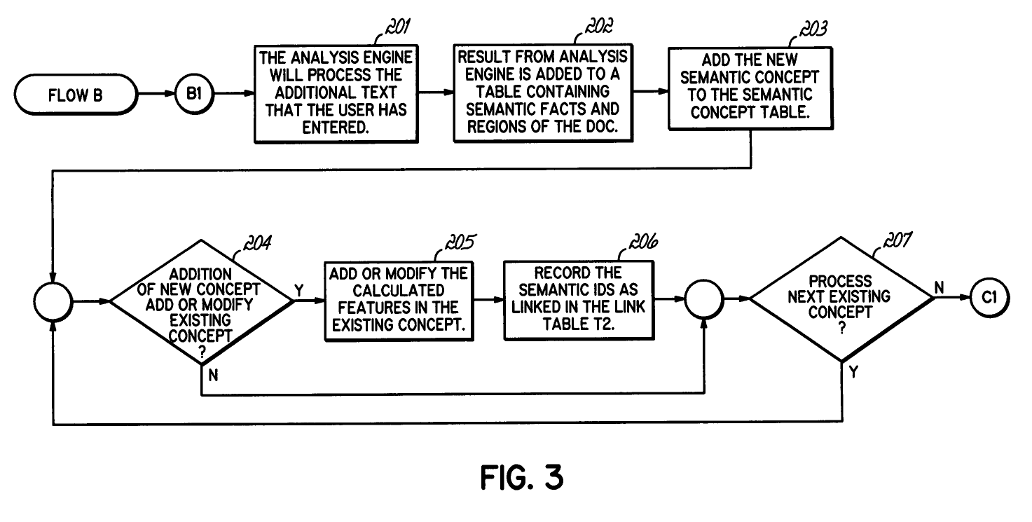

If a determination is made that analysis needs to be performed, then the process continues with Flow B in FIG. 3 (discussed below). Otherwise, control passes to block 103, where the user is presented with the opportunity to manually create a semantic link. If the user does not choose to create a semantic link, then control returns to block 101 to enable the user to continue to enter text or otherwise use the word processor. A request to create a semantic link may be input in a number of manners, e.g., via control button, key press, menu item, context menu item, etc., whether input before or after text has been highlighted by the user.

If the user does request to create a semantic link, then in block 104, the user will select the two portions or regions of the document that the user wishes to link together via a semantic link. Each of these regions may be manually highlighted by a user, or in the alternative, the regions may be automatically detected as a result of semantic analysis, whereby selection of the regions may occur simply through the selection of one or both regions that have previously been detected to be logically related as a result of such analysis. Automatic detection of logically-related regions is discussed in greater detail below in connection with FIG. 3. As discussed below, as a result of such detection, an entry may be created in a semantic fact table to represent the logical relation between the regions.

Next, in block 105, the user selects a feature based on the semantic meaning of a word or linguistic expression in one of the regions, which is designated the “source region” for the semantic link. Then, in block 106, a matching feature is created in the semantic fact table for the other portion of the document, designated the “target region” for the semantic link. The matching feature has the same value as the user selected feature in the source region. In some embodiments, where automated creation of semantic links is supported (as described below in connection with FIG. 3), the target region will initially lack the matching feature, as if the matching feature was already present, the automated detection process would have already created the link and the user would not have had to perform the steps necessary to manually create the semantic link. Otherwise, if only manual semantic link creation is supported, the matching feature may already be present when the link is created.

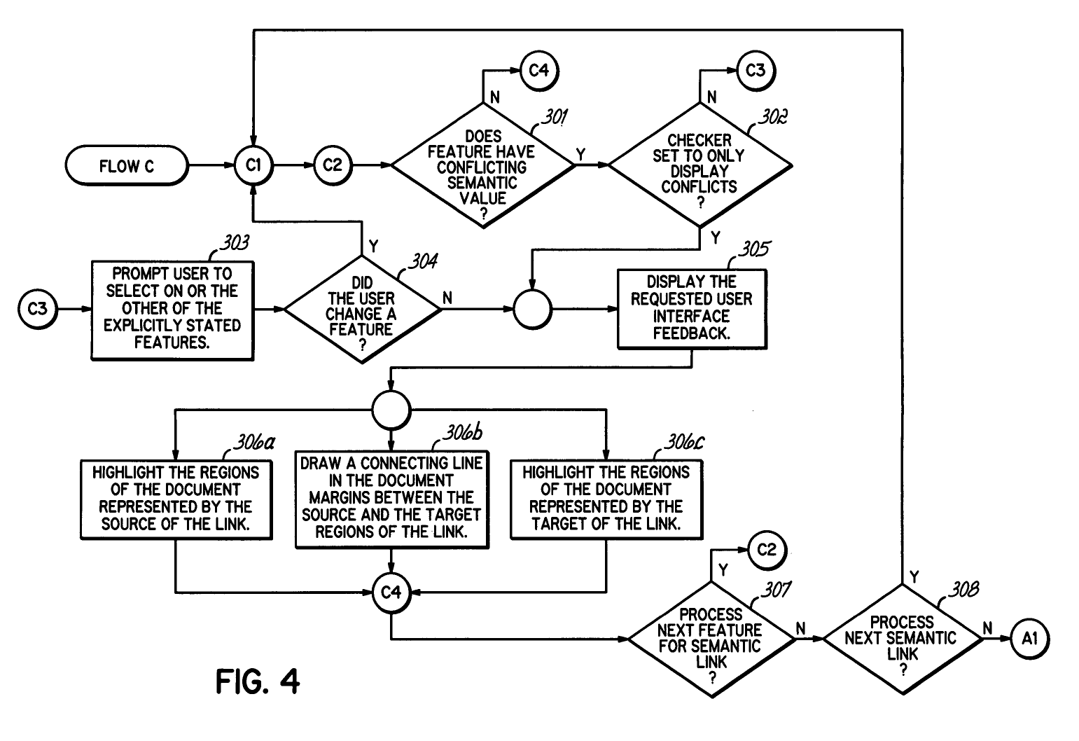

Once the matching feature has been created in the target region, control passes to block 107, where the semantic identifiers for the entries in the semantic fact table are recorded as being linked in the semantic link table, typically by adding an entry to the semantic link table identifying both semantic identifiers. The process then continues to flow C in FIG. 4.

Returning to block 102, if it is determined that a point for analysis has been reached, control passes to block 201 of FIG. 3, where the analysis engine processes any additional text that the user has entered. The sequence of steps starting with block 201 may also be used if the user has not enabled semantic link processing in a finished document and then turns it on or opens a finished document that has no semantic links and the semantic link processing is enabled. In the later case, the text to process would consist of the entire document. In block 202, the result from the text analysis engine is added to the semantic fact table. For example, a phrase recognized as a monetary expression for the text “100.55 US Dollars” would generate an annotation type for a monetary expression that covers the text and a feature of that expression would be that the currency symbol would be set to a “$”. In block 203, the new semantic concept is then added to the semantic fact table.

Block 204 then checks to see if the addition of the new semantic concept adds to or modifies an existing concept. If the new semantic concept does add to or modify an existing concept, then in block 205, the existing concept is modified to reflect those additions or modifications, e.g., by adding or modifying features in the entry for the existing concept. In block 206, the semantic identifiers for the concepts are then linked together by creating an entry in the semantic link table. This process continues in block 207 until there are no more existing concepts. The process then proceeds to Flow C in FIG. 4. Returning to block 204, if the new semantic concept does not affect an existing concept, control passes directly to block 207, bypassing blocks 205 and 206.

Turning to FIG. 4, after one or more semantic links has been established, either via block 107 (FIG. 2) or block 207 (FIG. 3), a loop is initiated in block 301 to process each feature in each semantic link to determine whether any calculated or stated feature has a conflicting semantic value, i.e., a semantic inconsistency. If, for a given feature associated with a given semantic link, there are no conflicting values block 301 passes control to block 307 to process the next feature in a semantic link, if one exists. If there is a conflicting semantic value indicating an inconsistency, however, block 301 passes control to block 302 to determine if the conflict is to just be highlighted or if there is some type of user interaction required.

If there is a user action required, in block 303, the user may be presented with a prompt displaying a set of options. If the user selects one of these options and in block 304 it is determined that the selection changes a feature, control returns to block 301 to restart the check of the current semantic link. If block 304 determines the selection doesn't change a feature, or if block 302 determines that the checker is set to only display inconsistencies, control passes to block 305, where the semantic link information is displayed to the user. This display of the information may include a number of different display techniques, including, for example, highlighting the source of the link in block 306a, highlighting the target of the link in block 306c, connecting the source and target of the link in block 306b, or any combination of those three or any other technique that would show the inconsistency to the user. Control then passes to block 307 to process the next feature of the current semantic link until all features in the link have been processed. Once all features have been processed, block 307 passes control to block 308 to process the next semantic link. Once all of the semantic links have been exhausted, the process returns to the user input in block 101 of FIG. 2.

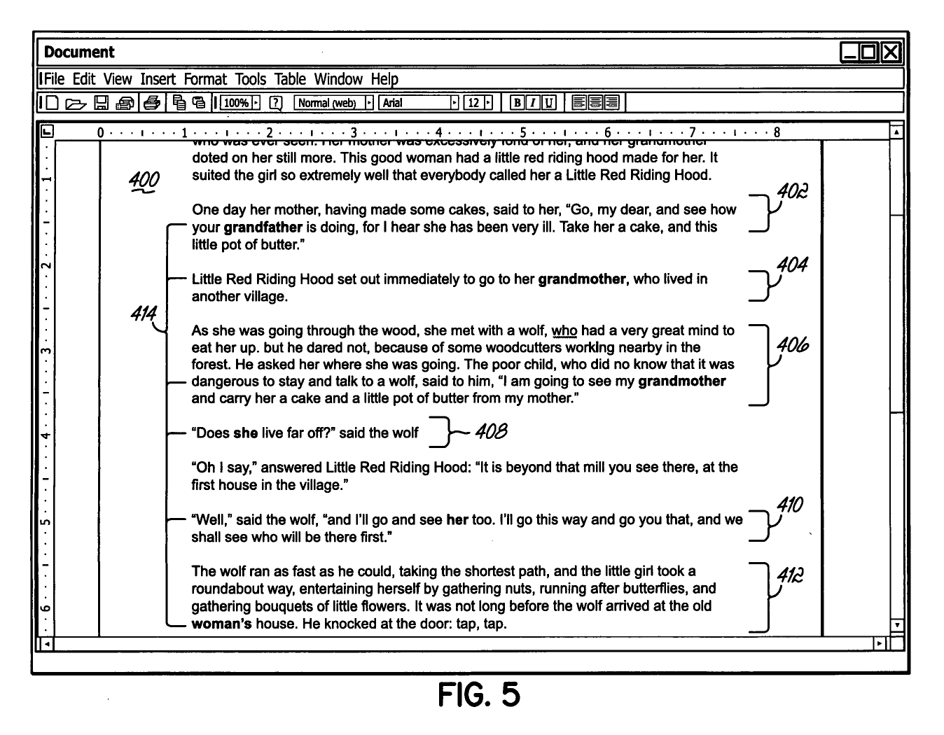

As noted above, the manner in which semantic links, and inconsistencies detected in association therewith, are represented on a computer display may vary in different embodiments. FIG. 5, for example, illustrates an exemplary electronic document 400 including portions or regions 402, 404, 406, 408, 410 and 412. Such regions, and one or more semantic links therebetween, may be created manually by a user, or alternatively may be automatically generated in response to text analysis as described herein. In each region 402-412, a feature related to gender is defined, relating to the concept of a “grandmother.” FIG. 5 illustrates a content modification to document 400, where the term “grandmother” has been changed to “grandfather” in region 402, resulting in a semantic inconsistency with all of the references to the same individual in regions 404-412. As a result, the semantic inconsistency is highlighted using both a sidebar graphic 414 with connecting lines shown in the document margin extending drawn between the affected regions, as well as applying a bold font effect to each inconsistent linguistic term or expression. Other manners of highlighting may include, for example, highlighting entire regions, using different effects such as font effects (e.g., italics, underlining, size, font face, etc.), shading, patterns, or colors, or other known highlighting mechanisms.

It will be appreciated that once the semantic inconsistency is detected, the logic checker may automatically make the modification to the linked portions of the document to overcome the inconsistency, or alternatively may provide a list of one or more suitable alternatives from which the user can select. The analysis may also be performed without any user input, or alternatively may require a user to request that automated updating or prompting of alternatives be performed by the logic checker. Other modifications will be apparent to one of ordinary skill in the art having the benefit of the instant disclosure.

### ILLUSTRATIVE EXAMPLE

Consider an electronic document related to computer system performance, where the document is composed of different sections including an Introduction and an Analysis section. In the introduction section, the document may contain four portions denoted Portions 1-4, each respectively incorporating the following linguistic expressions:
Portion 1: “During the testing phase, the test team created a simple 3-tier network with systems A, B, and C.”
Portion 2: “System A had 512 MB of main memory, contained one 1.9 Ghz processor, and cost two thousand dollars.”
Portion 3: “System B had 32 GB of main memory, contained four 3 Ghz processors and cost one-half million dollars.”
Portion 4: “System C had 64GB of main memory, contained eight 3 Ghz processors with 2 TB of disk space and cost three million dollars.”

The analysis section of the document may contain a fifth portion incorporating the following linguistic expression:
Portion 5: “With these measurements, we can start the analysis. Although it was complex, and had an approximate cost of two million dollars, our simple 3-tier network performed admirably. The number of users varied between the low and high as a result of . . . ”

In this example, annotators are provided that are programmed to recognize the commonly referred to term “system” (a computer), but not programmed with what a “3-tier network” is. Similarly, the annotator in this embodiment is programmed to recognize only a minimum of attributes: cost, simple, complex, and approximateness (as within 10%). A sample semantic fact table may be generated from this document using the steps described above in connection with FIG. 3 as follows:

Semantic Fact Table

| Seman- | | | | | |
|---|---|---|---|---|---|
| tic | Portion of | | | | Calculated |
| ID | Document | Type | Features | | Features |
| S1 | Portion 1 | Item | Name: | 3-tier network | Cost: |
| | | | Contains: | System A, | $3,502,000 |
| | | | | System B, | |
| | | | | System C | |
| | | | Attribute: | Simple | |
| S2 | Portion 2 | System | Name: | System A | |
| | | | Cost: | $2,000 | |
| S3 | Portion 3 | System | Name: | System B | |
| | | | Cost: | $500,000 | |
| S4 | Portion 4 | System | Name: | System C | |
| | | | Cost: | $3,000,000 | |
| S5 | Portion 5 | Item | Name: | 3-tier network | |
| | | | Cost: | $2,000,000 | |
| | | | Attribute: | Complex | |
| | | | Attribute: | Within 10% | |

The cost feature in S1 is defined as a calculated feature, and is based upon the sum of the explicit cost features in Portions 2-4. Other semantic facts (memory, speed, etc.) exist in the example document and would typically appear in this table; however, they have been omitted herein to simply the example.

Furthermore, as a result of the text analysis performed in the flowchart of FIG. 3, an example semantic link table may be generated as follows:

Semantic Link Table

| Source | Target |
|---|---|
| S1 | S2 |
| S1 | S3 |
| S1 | S4 |
| S5 | S1 |

As a result of processing the aforementioned document using the inconsistency checking of FIG. 4, a number of conflicting attributes would be detected in this document. First, an inconsistency would be detected between Portions 1 and 5 with relation to the cost features in each portion, specifically between S1: Cost(Calculated) and S5: Cost(Explicit). In addition, an inconsistency would be detected between S1: Simple(Explicit) and S5: Complex(Explicit).

As a result of logic checking, the inconsistencies may be highlighted and displayed to the user in the manner described above. In addition, if prompting of a user is enabled, the user may be prompted to rectify an inconsistency. For example, for the inconsistency between simple and complex, the user may be prompted to change the word “complex” in Portion 5 to another word such as “trivial,” thereby eliminating that inconsistency between the portions of the electronic document.

From the forgoing disclosure and detailed description of certain preferred embodiments, it will be apparent that various modifications, additions, and other alternative embodiments are possible without departing from the true scope and spirit of the present invention. For example, it will be apparent to those skilled in the art, given the benefit of the present disclosure, that the semantic links can be used in many different types of documents and are not just limited to word processing environments. The embodiments that were discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A computer implemented method for managing content in a document, the method comprising:
detecting a content modification to one of first and second portions of a document that are logically linked to one another by a semantic link, wherein the first portion of the document includes a linguistic expression;
analyzing the detected content modification to determine whether the content modification is a semantic modification that creates a semantic inconsistency between the first and second portions of the document, wherein the semantic inconsistency is based at least in part upon a meaning of the linguistic expression in the first portion of the document; and
acting on content in the other of the first and second portions of the document in response to determining that the content modification is a semantic modification.

2. The computer implemented method of claim 1, wherein the document further includes a third portion and a second semantic link defined between the third portion and at least one of the first and second portions of the document, the method further comprising acting on content in the third portion of the document in response to determining that the content modification creates a semantic inconsistency in the third portion of the document.

3. The computer implemented method of claim 1, wherein analyzing the detected content modification is performed using a text analysis engine that is configured to recognize a finite set of modifications that affect the semantic content of one of the first and second portions of the document.

4. The computer implemented method of claim 1, wherein acting on the content in the other of the first and second portions of the document comprises highlighting the content to indicate a further action is necessary.

5. The computer implemented method of claim 1, wherein acting on the content in the other of the first and second portions of the document comprises issuing a prompt to determine if further action is necessary.

6. The computer implemented method of claim 1, wherein acting on the content in the other of the first and second portions of the document comprises automatically modifying the content of the other of the first and second portions of the document to overcome the semantic inconsistency.

7. The computer implemented method of claim 6, wherein the content modification alters the meaning of the linguistic expression, and wherein automatically modifying the content in the other of the first and second portions of the document comprises automatically modifying a meaning of a second linguistic expression in the second portion of the document.

8. The computer implemented method of claim 6, wherein automatically modifying the content in the other of the first and second portions of the document comprises automatically modifying the meaning of the linguistic expression.

9. The computer implemented method of claim 1, wherein the content modification negates the meaning of the linguistic expression, and wherein analyzing the detected content modification to determine whether the content modification is a semantic modification comprises detecting a negation of the linguistic expression.

10. A computer implemented method for managing logically-related content, the method comprising:
detecting a content modification to one of first and second portions of content that are logically linked to one another by a semantic link, wherein the first portion includes a linguistic expression;
analyzing the detected content modification to determine whether the content modification is a semantic modification that creates a semantic inconsistency between the first and second portions, wherein the semantic inconsistency is based at least in part upon a meaning of the linguistic expression in the first portion; and
acting on content in the other of the first and second portions in response to determining that the content modification is a semantic modification.

11. The method of claim 10, wherein the first and second portions are disposed in the same electronic document, whereby the semantic link is associated with the electronic document.

12. The method of claim 10, wherein the first and second portions are respectively disposed in first and second electronic documents, whereby the semantic link is associated with each of the first and second electronic documents.

13. A computer implemented method for establishing a semantic link in a document comprising:
inserting content in a first portion of a document, the content in the first portion of the document including a linguistic expression;
inserting content in a second portion of the document that is logically related to the content of the first portion of the document; and
generating a semantic link in the document that logically links the content of the first portion of the document to the content of the second portion of the document, wherein the semantic link is configured to initiate performance of an action on content in one of the first and second portions of the document in response to a determination that a content modification made to content in the other of the first and second portions of the document is a semantic modification that creates a semantic inconsistency between the first and second portions of the document, wherein the semantic inconsistency is based at least in part upon a meaning of the linguistic expression in the first portion of the document.

14. The computer implemented method of claim 13, wherein generating the semantic link is performed in response to user input.

15. The computer implemented method of claim 13, wherein inserting content in the first and second portions of the document is performed in response to user input.

16. The computer implemented method of claim 13, further comprising analyzing the content in the first and second portions of the document to determine whether the content in the second portion of the document is logically related to the content of the first portion of the document.

17. The computer implemented method of claim 16, wherein analyzing the content in the first and second portions of the document is performed using a text analysis engine that is configured to recognize a finite set of linguistic expressions that affect the semantic content of the first and second portions of the document.

18. The computer implemented method of claim 16, wherein generating the semantic link is performed automatically in response to determining that the content in the second portion of the document is logically related to the content in the first portion of the document.

19. The computer implemented method of claim 16, further comprising prompting a user to create the semantic link in response to determining that the content in the second portion of the document is logically related to the content of the first portion of the document.

20. An apparatus, comprising:
at least one processor; and
program code configured to be executed by the processor to manage content in a document by detecting a content modification to one of first and second portions of a document that are logically linked to one another by a semantic link, wherein the first portion of the document includes a linguistic expression; analyzing the detected content modification to determine whether the content modification is a semantic modification that creates a semantic inconsistency between the first and second portions of the document, wherein the semantic inconsistency is based at least in part upon a meaning of the linguistic expression in the first portion of the document; and acting on content in the other of the first and second portions of the document in response to determining that the content modification is a semantic modification.

21. The apparatus of claim 20, wherein the program code is configured to analyze the detected content modification using a text analysis engine that is configured to recognize a finite set of modifications that affect the semantic content of one of the first and second portions of the document.

22. The apparatus of claim 20, wherein the program code is configured to act on the content in the other of the first and second portions of the document by performing an action selected from the group consisting of highlighting the content to indicate a further action is necessary, issuing a prompt to determine if further action is necessary, and automatically modifying the content of the other of the first and second portions of the document to overcome the semantic inconsistency.

23. The apparatus of claim 20, wherein the content modification alters the meaning of the linguistic expression, and wherein the program code is further configured to automatically modify a meaning of a second linguistic expression in the second portion of the document.

24. The apparatus of claim 20, wherein the program code is further configured to automatically modify the meaning of the linguistic expression.

25. A program product, comprising:
program code configured to manage content in a document by detecting a content modification to one of first and second portions of a document that are logically linked to one another by a semantic link, wherein the first portion of the document includes a linguistic expression; analyzing the detected content modification to determine whether the content modification is a semantic modification that creates a semantic inconsistency between the first and second portions of the document, wherein the semantic inconsistency is based at least in part upon a meaning of the linguistic expression in the first portion of the document; and acting on content in the other of the first and second portions of the document in response to determining that the content modification is a semantic modification; and
a computer readable medium bearing the program code.
